(19) United States
(12) Patent Application Publication
(10) Pub. No.: US 2026/0227021 A1
(43) Pub. Date: Aug. 6, 2026

(54) DEVICE, SYSTEM AND METHOD FOR LOCATING AND REPAIRING LEAKS IN PIPES

(71) Applicant: South East Water Corporation, Frankston, Victoria (AU)

(72) Inventor: Andrew FORSTER-KNIGHT, Frankston, Victoria (AU)

(21) Appl. No.: 19/151,897

(22) PCT Filed: Dec. 22, 2023
(86) PCT No.: PCT/AU2023/051371

§ 371 Date: Jul. 29, 2025

(30) Foreign Application Priority Data
Jan. 30, 2023 (AU) 2023900209
Dec. 21, 2023 (AU) 2023904185

(51) Int. Cl. F16L 55/1645; F16L 55/18; G01M 3/24

(52) U.S. Cl. CPC F16L 55/1645; F16L 55/18; G01M 3/246

(57) ABSTRACT

A device, system and method that can be used to locate a leak in a pipe, release a sealing pellet close to the location of the leak, and assess whether the leak has been sealed by the sealing pellet. An elongate probe device is disclosed that can be inserted into a fluid filled pipeline through a stop tap while carrying a sealing pellet, detect the location of a leak, and then release the sealing pellet close to the location of the leak to facilitate successful sealing of the leak.

### CROSS-REFERENCE TO RELATED APPLICATIONS

This application relates to and claims priority benefits from WIPO Application No. PCT/AU2023/051371, filed 22 Dec. 2023 which claims priority to AU 2023900209, filed Jan. 30, 2023 and AU 2023904185, filed Dec. 21, 2023. Each of these priority applications is incorporated by reference herein in its entirety.

### FIELD OF THE INVENTION

This invention relates to a device, system and method for locating and repairing leaks in pipes used to transport liquids.

### BACKGROUND

Leaks in pipelines carrying fluid, such as water, can lead to various undesirable results such as reduced pressure in the pipeline, contamination of the fluid and/or the external environment, wastage, and burst pipes that can damage the environment and infrastructure. Pipelines carrying water are usually situated underground, which makes the process of locating and repairing leaks difficult and expensive. Conventional methods for repairing leaks in pipelines involve estimating the approximate location of a leak using aboveground indicia such as localised wet earth or detectable sound, excavating down to the pipe, identifying the exact leak location, and then repairing the pipe from the outside. Locating the leak from above is often imprecise, and excavation through hard surfaces such as roads and footpaths may be necessary to access the pipe. Leaks can also be located under trees, wherein excavation results in damage to or removal of the tree, which requires local government approval. This method is therefore expensive, difficult, and can involve significant safety risks for personnel.

Pipes connecting individual properties to a water main are known as service lines. These pipes typically have a relatively small nominal diameter (e.g. in the order of 20 mm), and can extend for a length of 15 metres or more from the water main to the stop tap and water meter for the individual property. Since the water main is usually located on public land (or a public easement) and the stop tap/water meter is located on the individual property, service pipes typically pass beneath the property boundary, which may have an associated wall, fence, pathway or other obstruction. Moreover, leaks in small pipes such as service lines may be the result of small holes (e.g. in the order of millimetres in diameter). Due to the aforementioned difficulties of locating and accessing the site of a leak in service lines, the costs associated with fixing a leak may outweigh the benefits of repairing it.

Devices for repairing a leak from inside a pipe have previously been proposed. Conventionally, these methods comprise a sealing element composed of a central core formed from a deformable material, and a coating formed from a two-part epoxy putty. The sealing element typically has a density substantially the same as the density of the fluid in the pipe such that it is neutrally buoyant. To repair a leak, the sealing element is introduced into a pipeline at an access point upstream of the leak (typically an outlet of a hydrant valve). The sealing element then travels to the location of the leak following the bulk flow of the fluid in the pipe. The low pressure region at the location of the leak attracts the sealing element to the wall of the pipe and causes the coating of the sealing element to be partially extruded through the hole in the pipe wall thereby sealing the leak.

Repairing leaks in service lines with sealing elements has only limited success in practice. Often the closest point of access from which to release the sealing elements is many metres from the location of the leak and there is no guarantee that the sealing elements will travel to the site of the leak. To mitigate this, several sealing elements are often released into the pipe to increase the likelihood that one of them will seal the leak. This has the adverse consequence of having sealing elements in the pipelines that might lead to blockages elsewhere, or be ejected from a kitchen or bathroom tap. Additionally, the sealing elements are more effective at sealing larger holes. Since holes in service lines are typically quite small, the conventional methods of deploying sealing elements can be limited in effectiveness.

### SUMMARY OF THE INVENTION

This invention relates to a device that can be used to locate a leak in a pipe, release a sealing element (e.g., sealing pellet) close to the location of the leak, and assess whether the leak has been sealed by the sealing element. Embodiments of the invention as disclosed herein provide an elongate probe device that can be inserted into a service line through a stop tap while carrying a sealing element, detect the location of a leak, and then release the sealing element close to the location of the leak to facilitate successful sealing of the leak.

In accordance with the present invention there is provided a device for use in locating and repairing a pipe leak, comprising a flexible elongate probe, the probe having a head portion at a distal end thereof adapted for insertion into a fluid containing pipe, the head portion being equipped with a sensor for detecting a nearby fluid leak in the pipe and means for holding and releasing a sealing element at or nearby the detected fluid leak location.

The sensor may comprise a microphone or hydrophone, for example, which can be used to detect sound or noise indicative of fluid passing through a hole or crack in the pipe. The head portion may additionally or alternatively be equipped with a camera sensor and light source which can be used to visually detect and/or inspect the location of the fluid leak.

In embodiments of the invention, the means for holding and releasing the sealing element comprises a mechanical clamp or grasping mechanism that can be remotely released from the proximal end of the device. For example, the means for holding and releasing the sealing element may be mechanically coupled through the flexible elongate probe to a user operable actuator at the proximal end of the probe. A Bowden cable or the like may be used for the mechanical coupling.

In embodiments of the invention, the head portion of the probe device may itself be elongate in form, at least to the extent that there is a longitudinal separation between the means for holding the sealing element and the sensor. A flexible barrier formation may be provided at an intermediate location on the head portion, preferably close to the sensor, the barrier formation permitting fluid flow in the pipe but impeding passage of the sealing element. Preferably the sensor and flexible barrier formation are located at the proximal end of the head portion, and the means for holding and releasing the sealing element located at or near the distal end. The distal end of the head portion may be attached by way of a flexible section for enhanced manoeuvrability of the probe.

The present invention also provides a system for locating and repairing a leak in a pipe, comprising: a pressure sealing insertion chamber adapted for attachment to a stop tap fluidly coupled to the pipe; a probe device capable of extending through the pressure sealing insertion chamber and having a head at its distal end, wherein the probe device head is equipped with a sensor for detecting a nearby fluid leak in the pipe when inserted therein, and means for holding and releasing a sealing element; and an actuator configured to selectively release the sealing element from the head of the probe device when actuated.

In embodiments of the invention the pressure sealing insertion chamber is adapted for attachment to, and sealing of, a stop tap such that the stop tap can be opened without substantial fluid flow from the pipe during use of the probe device.

In embodiments of the invention the probe device head has an ogive shape for easier insertion through the stop tap. The head preferably has a cavity to house the sealing element and an aperture through which to release the sealing element.

The means for holding and releasing the sealing element may comprise a spring-loaded clamping mechanism configured to hold the sealing element in the cavity. In one embodiment as described herein the actuator includes a Bowden cable coupled to clamping mechanism. The proximal end of the probe device has a trigger coupled to the Bowden cable for operating the clamping mechanism to selectively release the sealing element. Alternatively, the sealing element may be retained by the head of the probe device by means that are electrically actuated, rather than mechanically operated.

The present invention also provides a method for locating and repairing a leak in an underground water pipeline, the method comprising: closing a stop tap attached to a service line; attaching a pressure sealing insertion chamber to the stop tap, the pressure sealing insertion chamber having therein the distal end of a probe device including a head with a releasable sealing element; opening the stop tap and urging the probe device head through the open tap valve and into the service line in a direction opposite the main flow direction in the pipe; locating a leak site in the wall of the service line and releasing the sealing element from the probe device head when it is at or nearby the leak site.

After closing the stop tap, it may be necessary to decouple or remove an associated water meter before attaching the pressure chamber to the stop tap.

The method may further comprise employing at least one of a camera, light and/or hydrophone to locate the source of the leak, assess if the nature of the leak (e.g. size and shape of the hole) is suitable for repair with the sealing element, and/or assess whether the hole causing the leak has successfully been sealed by the sealing element following the repair procedure.

The present invention further provides a method for locating and repairing a leak in a water pipeline, the method comprising: inserting a probe device as disclosed herein into the pipeline through a pressure sealing insertion chamber attached to the stop tap, urging the head portion of the probe device into the pipeline to a location where the sensor indicates a leak; urging the probe device head portion past the leak location before releasing a sealing element therefrom; and slowly withdrawing the probe device head portion past the leak location.

### DESCRIPTION OF THE DRAWINGS

Embodiments of the invention are described hereinbelow, presented by way of non-limiting example only, and with reference to the accompanying drawings, in which:

FIG. 1 is a perspective view of the head on the distal end of a probe device according to a first embodiment of the invention;

FIG. 2 shows the probe device distal end with the head portion removed from the remainder of the device;

FIG. 3 is a side view of the probe device head portion;

FIG. 4 illustrates system components for use of the probe device in locating and repairing a leak in a service line, including a pressure sealing insertion chamber;

FIG. 5 illustrates the system of FIG. 4 assembled and coupled for use onto a stop tap;

FIG. 6 is a partial cross-sectional side view of a service line stop tap;

FIGS. 7 and 8 also show a probe device according to the first embodiment of the invention;

FIGS. 9 and 11 show the head portion of the probe device of FIGS. 7 and 8 in side and plan views, respectively;

FIGS. 10 and 12 are sectional views of the head portion as seen in FIGS. 9 and 11, respectively;

FIG. 13 is a perspective view of a probe device according to a second embodiment of the invention, together with system components for use of the probe device in locating and repairing a leak in a service line;

FIG. 14 is an enlarged sectional view showing the structure of a flexible elongate member according to an embodiment of the invention;

FIG. 15 is an enlarged view of a portion of the probe device according to the second embodiment showing the base of the head portion;

FIG. 16 is diagrammatically illustrates an enlarged, cross-sectional view of the end of the head portion according to the second embodiment, deployed in a pipe;

FIG. 17 shows an actuator of a probe device according to an embodiment of the invention;

FIG. 18 is a cut-away view showing internal structure of the actuator of FIG. 17;

FIG. 19 is an exploded view of a system for use of the probe device;

FIG. 19A is an enlarged cut-away view of an insertion chamber assembly according to an embodiment of the invention;

FIG. 20 diagrammatically illustrates a process for deploying the probe device of the second embodiment to repair a pipe leak; and

FIG. 21 is a flow chart diagram illustrating a pipe leak repair procedure according to an embodiment of the invention.

### DETAILED DESCRIPTION

A probe device 10 according to embodiments of the invention has a flexible elongate member 15 with a head portion 20 at the distal end thereof. The head portion 20 has a cavity 22 which is open to one or both sides, the cavity 22 being adapted to receive a sealing element in the form of a small ball or pellet. The head portion includes means for retaining the sealing element in the cavity, and the probe is constructed to enable the sealing element to be selectively released from the cavity at a desired location.

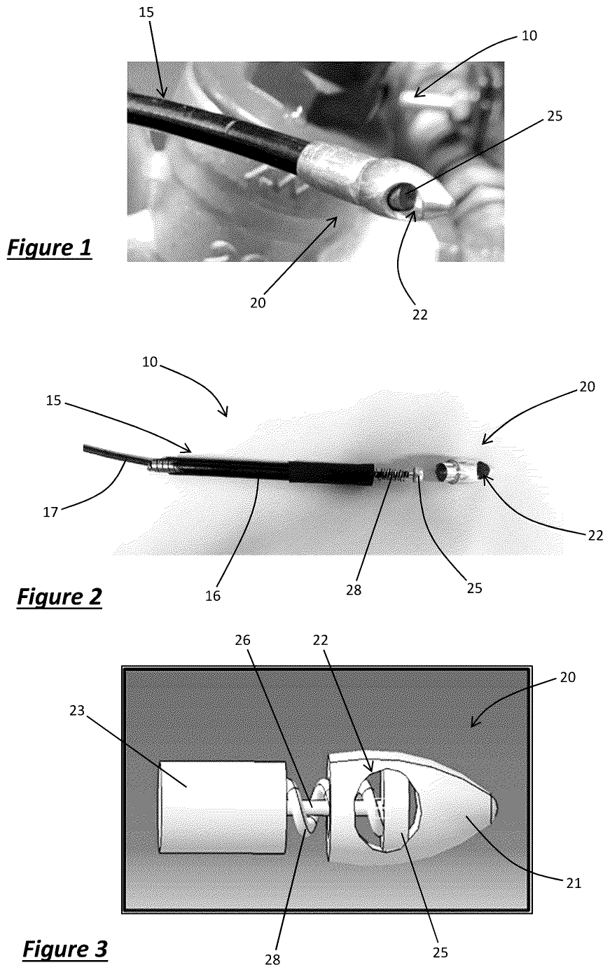

FIG. 1 shows the distal end of a probe device 10 according to an embodiment of the present invention. The probe device 10 comprises a head 20 on the end of a flexible elongate member 15, in this case a Bowden cable. The head 20 has an internal cavity 22 with an aperture opening to one side of the head 20. The head is ogive in shape and is configured to hold a sealing element in a captured position within the cavity while the head of the probe device 10 is urged through an open stop tap when in use. The ogive shape of the head 20 allows the probe device 10 to more easily be inserted through tight openings when in use. The sealing element, in use, is held within the cavity 22 of the head 20 between the end of a plunger 25 and an internal face of the cavity when in the captured position.

FIGS. 2 and 3 illustrate the mechanism of the probe device 10 that is used to release the sealing element from the captured position in more detail. A biasing member 28 (e.g. a compression spring) is configured to bias the plunger 25 towards the captured position. The plunger 25 is fixedly connected to a plunger shaft 26, which is connected by way of the Bowden cable to an actuator on the proximal end of the probe device. In some embodiments that actuator can be actuated mechanically. In other embodiments, the actuator can be electrically actuated.

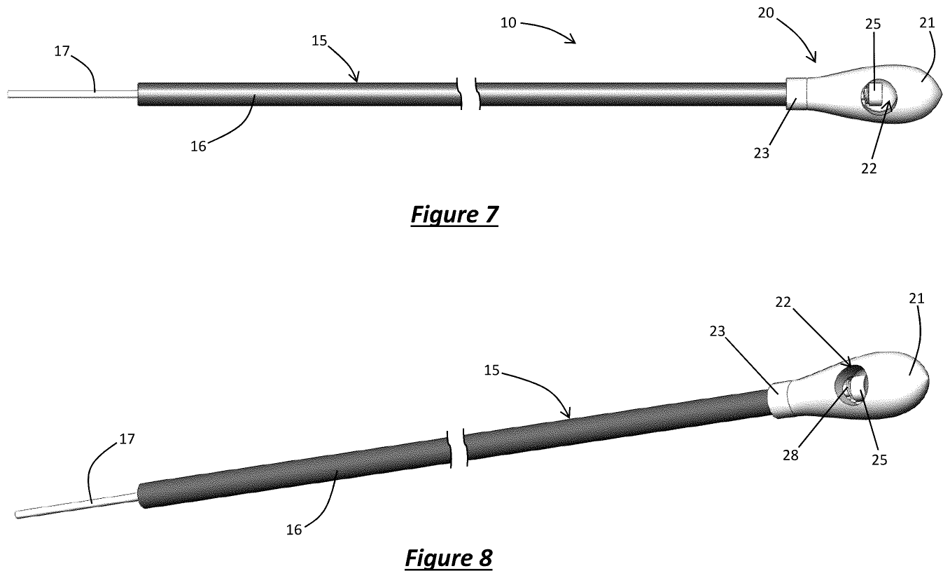

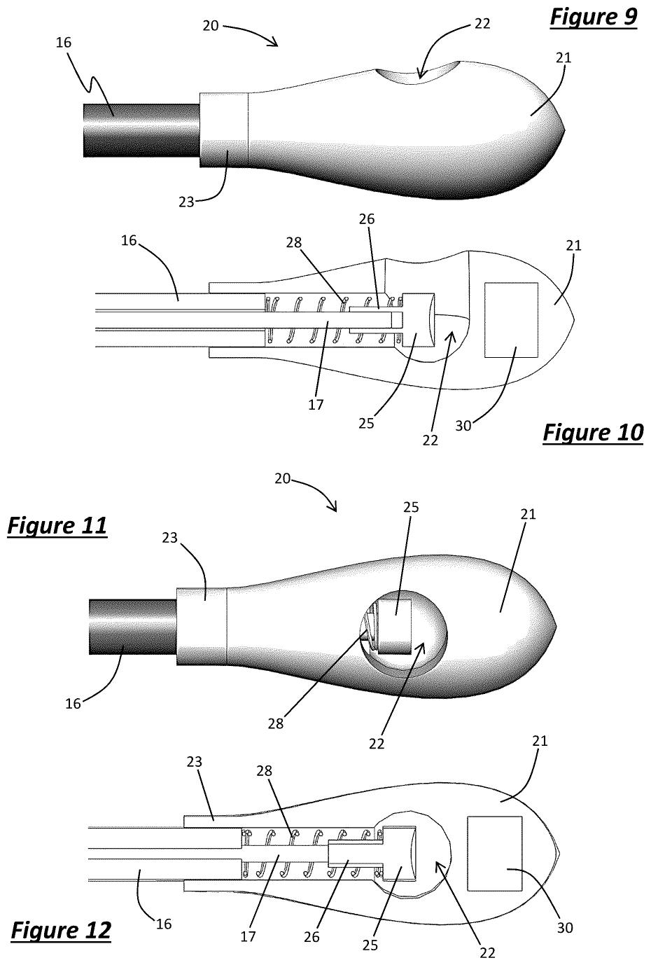

FIGS. 7 to 12 illustrate a probe device 10 and particularly the head portion 20 thereof according to an embodiment of the invention. The shape and dimensions of the head portion 20 as shown in these drawings is illustrative only. As noted above, the flexible elongate member 15 in this case is in the form of a Bowden cable having an outer sheath 16 and an inner cable 17. This allows the plunger 25 to be manipulated mechanically from the proximal end of the probe device, although in other embodiments the plunger may be operated by way of an electrical signal, using a solenoid or the like located in the head portion 20.

The head 20 as shown has a proximal end sheath 23 that is attached to the outer sheath 16 of the member 15. Meanwhile, the plunger 25 has a shaft 26 that is attached to the internal cable 17. The compression spring 28 acts between the end of the outer sheath 16 and the plunger 25 in order to bias the plunger into the cavity 22. Thus when a sealing element pellet (not shown) is placed in the cavity 22, it can be held in place between the plunger 25 and the internal wall surface of the cavity by force of the spring. In order to release the sealing element, an actuator at the proximal end of the probe is used to draw on the cable 17, relative to the outer sheath 16, which draws back the plunger and allows the sealing element to exit from the cavity.

The end 21 of the head portion 20 is also provided with one or more sensors 30 that may be used to determine the location of a fluid leak from inside the pipe, in use. For example, the sensor(s) 30 may include a microphone or hydrophone, coupled to convey signals to a receiver at the proximal end of the probe device 10, either wirelessly or by way of a communications cable (not seen) extending alongside or inside of the flexible elongate member 15. The microphone or hydrophone can be used to detect sound or noise indicative of fluid passing through a hole or crack in the pipe, and a maximum amplitude of the sound indicates when the head portion 20 of the probe is adjacent the hole. The sensor(s) 30 in head portion 20 may additionally or alternatively include a camera sensor and light source which can be used to visually detect and/or inspect the location of the fluid leak. As well as determining the location of a hole, the sensor(s) 30 may also be used to determine whether the sealing element released from the probe device has successfully sealed the fluid leak.

A procedure for use of the above described probe device in repairing a water leak is as follows. Consider a leak known or suspected to exist in a service line-the pipe extending from a water main to an individual property. A typical service line is fitted with a water meter preceded by a stop tap, located at or near the property boundary. Once the stop tap is closed, the water meter can be disconnected and a pressure tube attached in its place. The head portion of the probe is initially located within the pressure tube with the flexible elongate member extending out from the pressure tube through a seal that forms a watertight fitting when the stop tap is reopened. By pushing the flexible elongate member through the seal, the head portion of the probe can be urged through the stop tap valve and into the service line pipe. With the probe head inside the service line pipe, the site of the leak can be located with aid of the sensor(s) (e.g. microphone and/or camera) by inserting or retracting the probe until the head is appropriately positioned. The volume or intensity of sounds indicative of fluid leaking from a hole in the pipe may be used to determine the position along the pipe at which the leak is located. A camera in the head of the probe can be used to inspect the hole to confirm it is suitable for repair.

As described above, the head of the probe device holds a sealing element in the form of a small pellet. Once the probe head is positioned at the site of the leaking hole, the mechanism holding the sealing element is released on command of the device operator. Released from the probe head, the sealing element is drawn to the nearby leaking hole by the fluid. The sealing element lodges in the hole and forms a seal to prevent further fluid leakage. Success of the operation can be confirmed by use of the microphone and/or camera sensor(s). To finish, the probe device is withdrawn from the service line pipe through the stop tap, which is then closed while the pressure chamber is removed and the water meter reconnected.

FIGS. 4 and 5 show a prototype system 100 for locating and repairing leaks in pipes, attached to a stop tap assembly 40. The system 100 has a pressure tube 101 and an insertion tube 106. The pressure tube 101 is made of a flexible material so that it can be bent to permit the whole pressure chamber assembly to be fitted within the small gap that's left after a water meter is removed. One end of the pressure tube is sealingly connected to the stop tap assembly 40 using a threaded adapter 104 held on by hose clamp 102, and the other end is sealingly connected to the insertion tube 106 using a threaded adaptor 109 held on by hose clamp 103. A flow prevention valve 108 is inserted in an insertion tube 106 and provides a means for the probe device to enter the pressure tube 101 while preventing the movement of fluid into the insertion tube 106 when the stop tap is in an open position. The flow prevention valve 108 is sealed at each end with gaskets 107. The insertion tube 106 has a female thread 110 that can be connected to the male thread of the threaded adaptor 109.

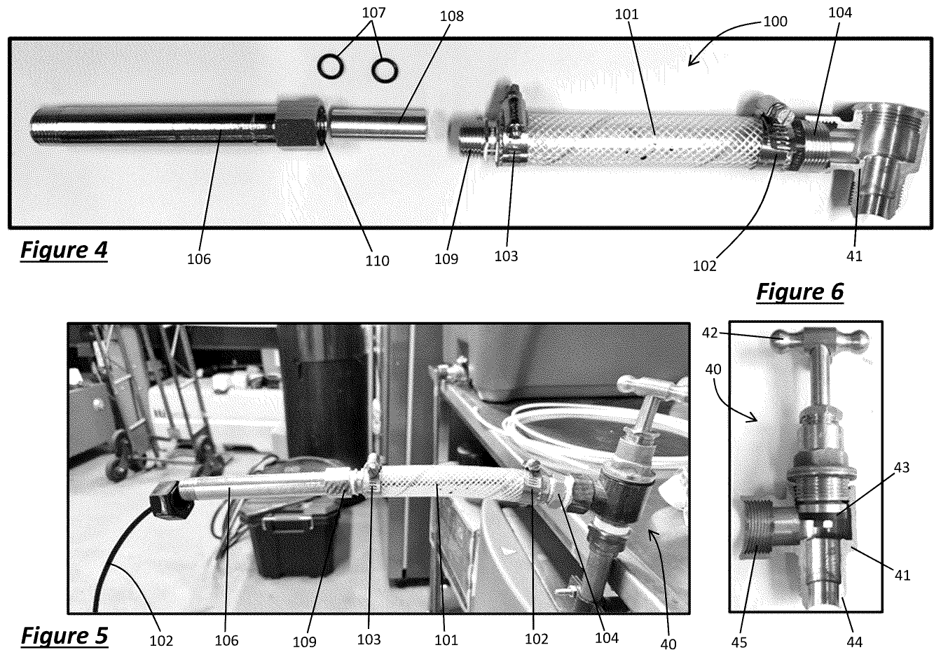

FIG. 6 shows a cross section of a stop tap assembly 40 comprising a tap body 41, a tap handle 42, a washer 43, a tap inlet 44, and a tap outlet 45. The stop tap 40 is shown in the open position in which the washer 43 is positioned so that it allows the flow of water from the tap inlet 44 to the tap outlet 45. Ordinarily, the tap outlet 45 is indirectly connected to a water meter (not shown). In order to attach the device 10 to the tap outlet 45, the stop tap assembly 40 is configured in the closed position, the water meter is disconnected from the tap outlet 45, and the pressure tube 101 is connected to the tap outlet 45 using the threaded adapter 104. Once the device 10 is connected, the stop tap can be opened, water from the service line (not shown) can then flow into the pressure tube 101, but is prevented from escaping by the flow prevention valve 108.

The head 20 of the probe device 10 with a sealing element in the captured position can then be urged through the tap outlet 45 of the open stop tap assembly 40 and through the tap inlet 44 into the attached service line.

When in the service line, the sealing element is carried ‘upstream’ by the probe device 10 while in the captured position and the camera, light and hydrophone on the head 20 of the probe device 10 can be used to locate any leaks in the pipe. A leak will typically be located by monitoring the sound recorded by the hydrophone and noting where a significant increase in the signal occurs. Once located, the size and shape of the hole at the site of the leak can be determined using the camera and light. If the size of the hole at the site of the leak is found to be smaller than the diameter of the sealing element, the probe device may be urged slightly further upstream so that the sealing element will travel towards the location of the leak when released. After the sealing element has been released, the hydrophone, camera and light can be used to confirm that the leak has been successfully repaired. If the size of the hole at the site of the leak is found to be larger than the diameter of the sealing element, or, if the hole is a long and thin split rather than a small approximately round hole, the sealing element may not be suitable to repair the leak and an alternative method may be required.

A system 200 for detecting and repairing leaks using a probe device 210 according to another embodiment of the invention is shown in FIGS. 13 to 19. FIG. 13 shows operative components of the system, including the probe device 210 which in this case has an elongate head portion 220. The head portion 220 is on the distal end of a flexible elongate member 215, the proximal end of which is connected to an actuator assembly 260 provided with a release trigger 265.

The head portion 220 has an in-built, sealed microphone (sensor 230) at its proximal end, near where the head portion is attached to the flexible elongate member 215. The head portion 220 has a tube shaft 240 extending from its attachment with the member 215 to a flexible end section 245. At the distal end 250 of the head portion the probe has a pellet release mechanism 255 and an angled tip 251. Marginally forward along the tube shaft from the sensor 230 the head portion 220 is provided with a barrier structure in the form of a brush formation 235 that encircles the tube shaft.

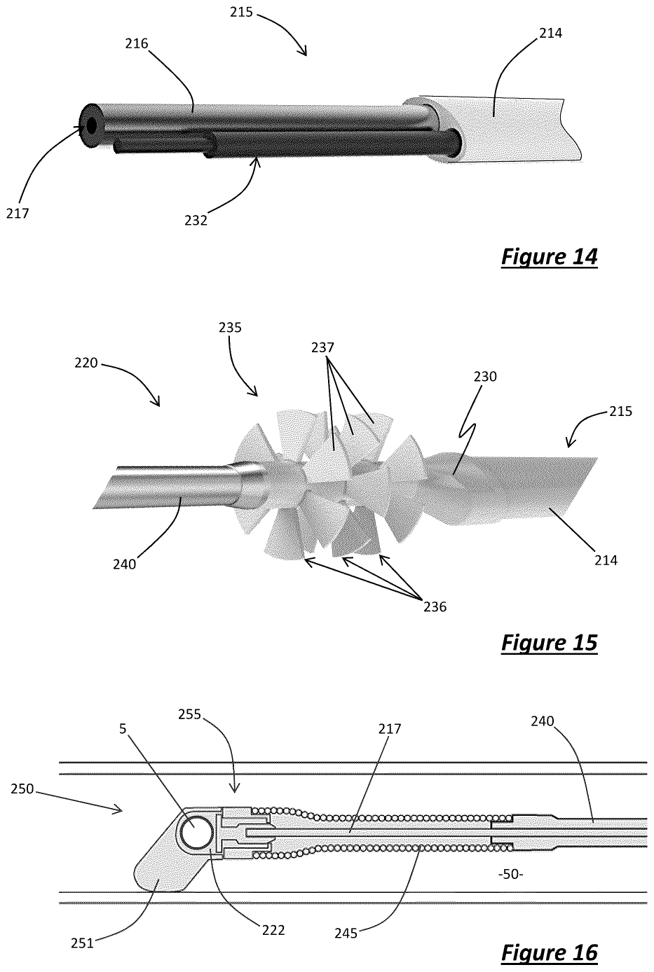

The structure of the flexible elongate member 215 according to an embodiment of the invention can be seen in FIG. 14 which shows an enlarged cut-away view thereof. In this embodiment the flexible elongate member 215 comprises an extruded sheath 214 that has an oval-shaped outer profile and two lumens extending therethrough, one carrying the Bowden cable 217 and sheath 216, and the other carrying a signals cable 232 for conveying signals from the sensor 230 to a detector 270 (FIG. 13).

FIG. 15 shows detail of the brush formation 235 that acts as a form of barrier for purposes explained below. The brush formation 235 in this embodiment comprises a plurality of flexible disks 236 spaced from one another along the proximal end of the tube shaft 240, each of the disks 236 extending radially outward to an extent approximately corresponding to the internal size of the pipe to be repaired. The disks 236 have segments removed leaving each disk with a plurality of vanes 237 arranged around the circumference of the shaft. The spaces between the vanes as between adjacent disks 236 are staggered to create a convolute fluid flow path when the probe 210 is situated in the pipe.

The distal end 250 of the probe head 220 is diagrammatically illustrated in enlarged, cross-sectional view in FIG. 16, carrying a sealing element pellet 5 and deployed inside a pipe 50. As shown, the angled tip 251 has rounded edges and protrudes radially to an extent that, when the tip 251 is in contact with the wall of the pipe, in use, the central axis of the probe head is maintained in the middle of the pipe 50. The sealing element pellet 5 is, during use of the probe, initially held in a cavity 222 near the tip of the probe head end, and maintained in place by the release mechanism 255 which is coupled to the distal end of Bowden cable 217 that extends from the elongate flexible member 215 and through the inside of the tube shaft 240. The release mechanism may comprise a clamshell arrangement, for instance, which clamps around the pellet 5 while tension is maintained on the Bowden cable 217. When tension on the cable 217 is released, the clamshell arrangement opens, releasing the captive pellet 5 into the fluid interior of the pipe 50.

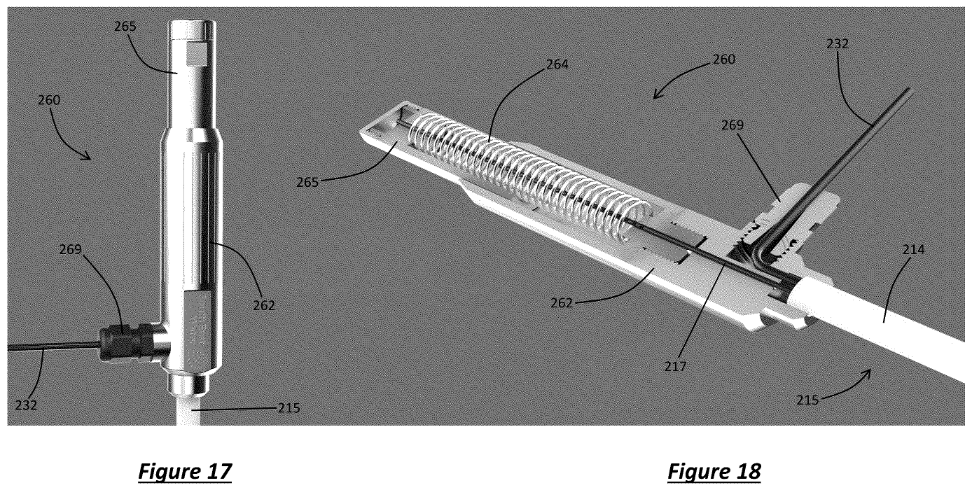

During use, tension is maintained on the cable 217 by the spring-loaded actuator 260 which has a tubular body 262 supporting a slideable, coaxial release trigger plunger 265. The end of the flexible elongate member 215 terminates at one end of the tubular body 262, opposite the plunger 265. The cable 217 extends through the tubular body and the proximal end of the cable 217 is connected to the plunger 265. A biasing spring 264 is housed in the tubular body 262 (FIG. 18) and acts between the body 262 and the plunger 265 as to maintain tension on the cable 217. The tension on the cable 217 can be released during operation of the probe device by a user pressing on the end of the release trigger plunger 265 so as to depress it relative to the tubular housing 262, against the resilient force of the biasing spring.

The body 262 has an opening on the side to permit the signals cable 232 to exit by way of a sealing gland 269. The signals cable 232 is connected to the detector 270 which includes amplification circuitry and the like contained in an IP-rated enclosure for in-field use. Signals from the detector 270 can then be provided to an external audio amplifier and/or external transmission circuit 275. For instance, a Bluetooth adapter may be provided to send the audio signals derived from the sensor 230 to an external speaker or headphones.

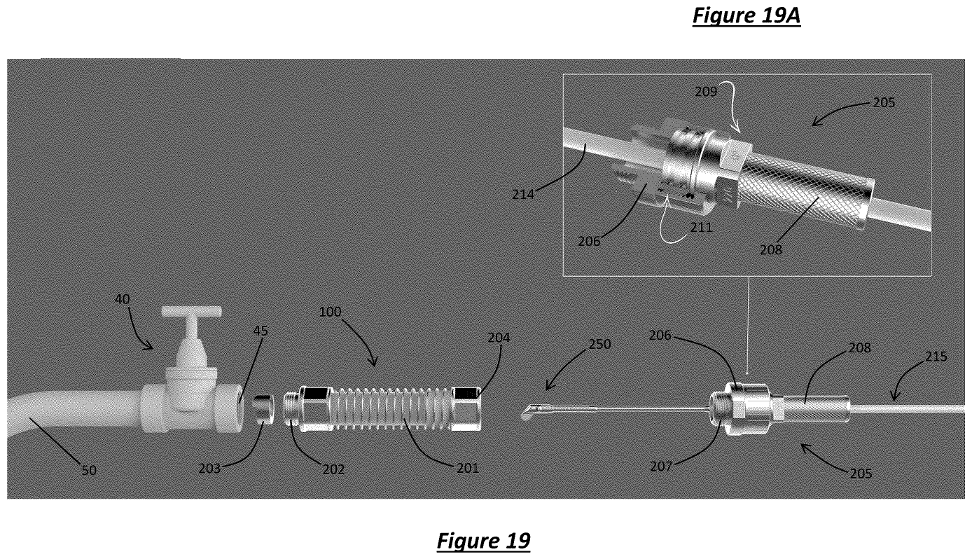

An exploded view of a system for use of the probe device 210 to repair service line pipe 50 by way of a T-junction stop-tap 40 is shown in FIG. 19. In use, the flexible elongate member 215 extends through the centre of an insertion chamber sealing assembly 205 which forms part of the insertion chamber 100. The sealing assembly 205 has a chamber interface member 206, the distal end of which has a screw threaded coupling to connect with the proximal end 204 of flexible extension tube 201. The distal end of the extension tube has a screw-threaded fitting 202 for connection to the stop-tap outlet thread 45. A navigation guide insert 203 may be temporarily inserted into the stop-tap outlet during use of the system, to aid the probe tip in navigating the T stop-tap.

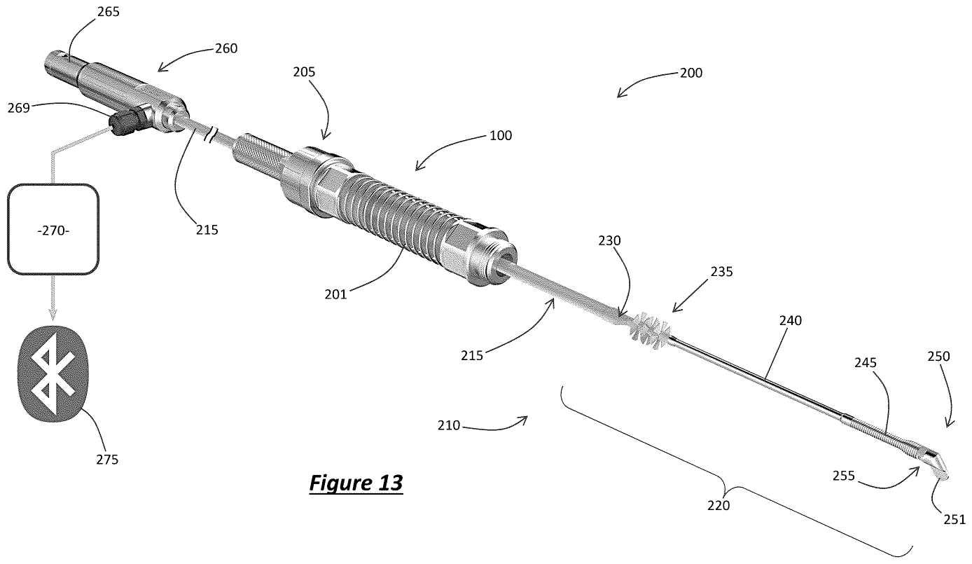

The chamber interface member 206 rotatably supports a sealing barrel 208, through the centre of which runs the flexible elongate member 215. O-rings or other sealing measures (not seen) are preferably provided between the bore of the sealing barrel and the outside surface of the sheath 214, to prevent excessive fluid leakage. The seals must nevertheless allow the flexible elongate member to slide longitudinally during insertion and withdrawal of the probe in the pipe 50. O-ring seals 211 are also provided between the inside bore of the interface member 206 and the outside surface of the sealing barrel 208 (FIG. 9A), permitting rotational movement of the barrel and with it the probe 210. Manipulation of the sealing barrel during use permits the operator to rotationally orient the tip of the probe as may be desirable during insertion into the pipe and release of the pellet. Markings 209 provide an indication of the probe orientation relative to the tip thereof.

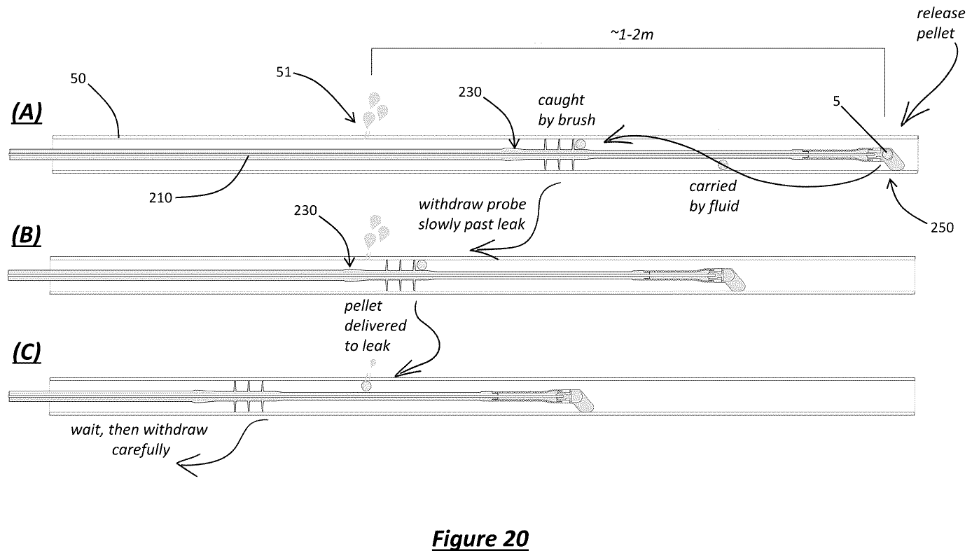

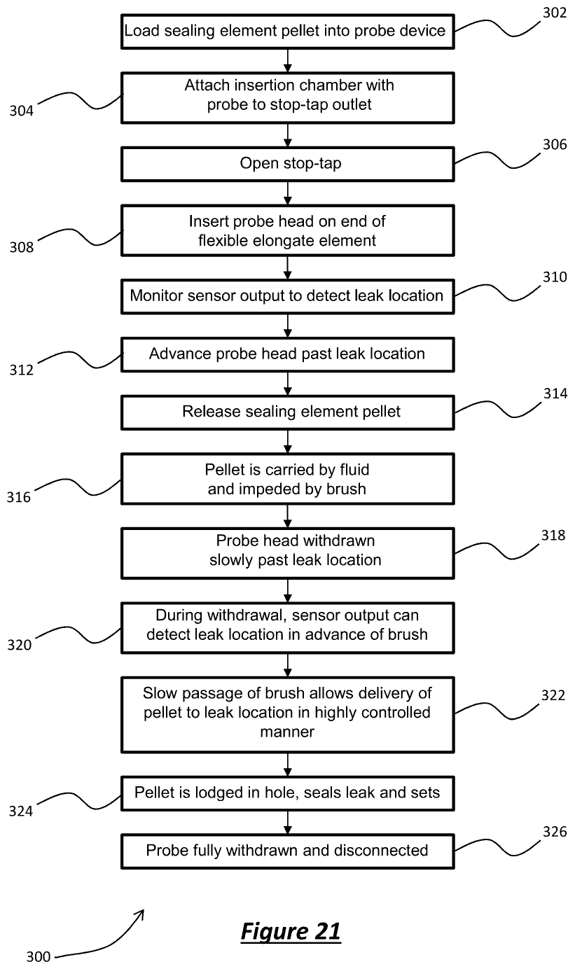

FIG. 20 diagrammatically illustrates the process of deploying the probe device 210 to repair a leak 51 in pipe 50. Meanwhile, FIG. 21 is a flow chart diagram illustrating the more detailed operations that may be involved in a pipe leak repair procedure 300 according to an embodiment of the invention. To prepare the system for repairing a leaking pipe, a sealing element pellet 5 is loaded into the cavity of the probe head and retained therein by action of the release mechanism (operation 302). The insertion chamber 100, with the head of the probe device 210 fitted therein, is attached to the stop-tap outlet (operation 304). With the stop-tap open (operation 306), the head of the probe device is fed through the tap valve and into the pipe 50 with negotiation through the restricted passage aided by the flexible section 245 of the probe head 220. The probe head 220 is advanced into the pipe 50 by feeding the flexible elongate member 215 into the insertion chamber through the sealing barrel 205 (operation 308) while monitoring output signals (e.g. audio) from the microphone sensor 230 (operation 310).

When the output signals indicate that the sensor 230 is nearby the location of the pipe leak 51, for example by producing a hissing sound or signal waveform characteristic of the noise typically emanating from a leaking pipe, the probe device is then advanced further into the pipe by perhaps another metre or two such that the entire probe head 220 is beyond the leak location (operation 312, FIG. 20 (A)). Then, the sealing element pellet 5 can be freed through operation of the release mechanism 255 by means of the Bowden cable and actuator 260 (operation 314).

Once released, the pellet 5 is carried by fluid flow toward the leak location until it reaches the brush formation 235. The gaps between the vanes 237 of the brush formation are too narrow to permit the pellet to pass therebetween, so the pellet 5 is prevented from further axial movement but not constrained from radial and/or circumferential displacement (operation 316, FIG. 20 (A)). The probe head is then withdrawn (operation 318) until the sensor 230 is able to detect the location of the pipe leak again (operation 320, FIG. 20 (B)). The brush formation 235 can be beneficial also in detecting the leak location, because the staggered windmill-like vanes 237 partially obstruct the fluid flow and create turbulence around the leak site, allowing the microphone sensor 230 to better detect the noise from the flow of water. Further, slow withdrawal of the brush formation 235 past the leak location allows delivery of the sealing element pellet to the leak location in a highly controllable manner (operation 322). This maximises the chances of the sealing element pellet successfully lodging in the pipe hole and effectively sealing the leak (operation 324, FIG. 20 (C)). After allowing time for the sealing element pellet to set, the probe device 210 can be fully withdrawn from the pipe and decoupled from the tap (operation 326).

In terms of the sealing element itself, the specification of Australian patent number 2018267281 discloses items and materials that may be used in conjunction with embodiments of the present invention, for example in the form of a small pellet which has one or more layers comprising a two-part epoxy putty. In use, the epoxy putty is partially extruded through the hole in the pipe by force of the fluid pressure, whereupon the material sets hard and seals the leak. Other forms of sealing element may alternatively be employed for use with the present invention, as will be understood by those of skill in the art.

Although the embodiments of the probe device illustrated herein and described above employ a clamping mechanism to retain the sealing element in the head portion in order to carry the sealing element to the location for deployment, other ways of retaining the sealing element are also contemplated. For example, the head portion of the probe may be constructed with a cavity that has a remotely operable door or other form of retaining latch, which slides, pivots or rotates to open the cavity to release and/or eject the sealing element therefrom.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

While various features of embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

1-24. (canceled)

25. A device for use in locating and repairing a pipe leak, comprising a flexible elongate probe, the probe having a head portion at a distal end thereof adapted for insertion into a fluid containing pipe, the head portion being equipped with a sensor for detecting a nearby fluid leak in the pipe and means for holding and releasing a sealing pellet at or nearby a detected fluid leak location.

26. The device of claim 25, wherein the sensor comprises a microphone or hydrophone.

27. The device of claim 25, wherein the means for holding and releasing the sealing pellet comprises a mechanical clamp or grasping mechanism, or an electrically actuated clamp or grasping mechanism.

28. The device of claim 27, wherein the means for holding and releasing the sealing pellet is mechanically or electrically coupled through the flexible elongate probe to a user operable actuator at a proximal end of the probe.

29. The device of claim 25, wherein the head portion is further equipped with a camera and a light to enable inspection of an inside of the pipe.

30. The device of claim 25, wherein the head portion of the probe device is elongate in form, at least to the extent that there is a longitudinal separation between the means for holding and releasing the sealing pellet and the sensor.

31. The device of claim 30, wherein a flexible barrier formation is configured to be provided at a location on the head portion intermediate the sensor and the means for holding and releasing the sealing pellet.

32. The device of claim 31, wherein the flexible barrier formation is located close to the sensor, the flexible barrier formation permitting fluid flow in the pipe but impeding longitudinal passage of the sealing pellet.

33. The device of claim 31, wherein the sensor and the flexible barrier formation are located at a proximal end of the head portion, and the means for holding and releasing the sealing pellet located at or near the distal end.

34. The device of claim 33, wherein the distal end of the head portion is attached by way of a flexible section for enhanced manoeuvrability of the probe.

35. A system for locating and repairing a leak in a pipe, comprising:
a pressure sealing insertion chamber adapted for attachment to a stop tap fluidly coupled to a pipe;
a probe device capable of extending through the pressure sealing insertion chamber and having a head at a distal end of the probe device;
wherein the head of the probe device is equipped with a sensor for detecting a nearby fluid leak in the pipe when inserted therein, and a means for holding and releasing a sealing pellet; and
an actuator configured to selectively release the sealing pellet from the head of the probe device when actuated.

36. The system of claim 35, wherein the pressure sealing insertion chamber is adapted for attachment to, and sealing of, a stop tap such that the stop tap can be opened without substantial fluid flow from the pipe.

37. The system of claim 35, wherein the head of the probe device has an ogive shape and includes a cavity to house the sealing pellet and an aperture through which to release the sealing pellet.

38. The system of claim 37, wherein the means for holding and releasing the sealing pellet comprises a spring-loaded clamping mechanism configured to hold the sealing pellet in the cavity.

39. The system of claim 38, wherein the actuator includes a Bowden cable coupled to the clamping mechanism.

40. The system of claim 39, wherein a proximal end of the probe device has a trigger coupled to the Bowden cable for operating the clamping mechanism to selectively release the sealing pellet.

41. A method for locating and repairing a leak in an underground water pipeline, the method comprising:
closing a stop tap attached to a service line;
attaching a pressure sealing insertion chamber to the stop tap;
providing a probe device with a distal end inside the pressure sealing insertion chamber, the distal end of the probe device having a head with a releasable sealing pellet;
opening the stop tap and urging the head of the probe device through the stop tap and into the service line in a direction opposite a main flow direction in the pipe; and
locating a leak site in a wall of the service line and releasing the sealing pellet from the head of the probe device when it is at or nearby the leak site.

42. The method of claim 41, further comprising using at least one of a camera, a light, or a hydrophone to assess if the sealing pellet is suitable for a size and a shape of a hole at the leak site.

43. The method of claim 41, further comprising using at least one of a camera, a light, or a hydrophone to one or more of locate the source of the leak or assess if a hole at the leak site causing the leak has successfully been sealed by the sealing pellet.

44. A method for locating and repairing a leak in a water pipeline, the method comprising: inserting a probe device according to claim 1 into the water pipeline through a pressure sealing insertion chamber attached to a stop tap, urging the head portion of the probe device into the water pipeline to a location where the sensor indicates a leak; urging the head portion of the probe device past the location of the leak before releasing a sealing pellet therefrom; and withdrawing the head portion of the probe device past the location of the leak.
